(19) United States
(12) Patent Application Publication
(10) Pub. No.: US 2026/0063974 A1
(43) Pub. Date: Mar. 5, 2026

(54) ANTI-LOOSENING AND ANTI-ROTATION QUICK-RELEASE PLATE FOR PHOTOGRAPHIC AND DIGITAL PRODUCTS

(71) Applicant: Dongjiang Li, Shenzhen (CN)

(72) Inventor: Dongjiang Li, Shenzhen (CN)

(21) Appl. No.: 19/298,142

(22) Filed: Aug. 12, 2025

(30) Foreign Application Priority Data
Aug. 30, 2024 (CN) 202422127788.4

(51) Int. Cl. G03B 17/56; F16M 11/04

(52) U.S. Cl. CPC G03B 17/561; F16M 11/041

(57) ABSTRACT

This application belongs to the technical field of fittings for photography and video recording and digital products and provides an anti-loosening and anti-rotation quick-assembly plate for photographic and digital products, including a quick-assembly plate and a large screw. A storage groove is formed in a lower side of the quick-assembly plate, and the large screw is disposed within the storage groove. An anti-loosening fastening assembly for preventing loosening of photographic equipment is disposed between the large screw and the quick-assembly plate, and includes a connection hole formed in a head of the large screw, a positioning hole formed in an inner top surface of the storage groove, and a fastener threadedly connectable between the connection hole and the positioning hole. This application solves the problem that a traditional quick-assembly plate becomes loose from photographic equipment in use.

### TECHNICAL FIELD

The present disclosure relates to the technical field of accessories for photography and videography equipment and digital products, and in particular, to an anti-loosening and anti-rotation quick-assembly plate for photographic and digital products.

### BACKGROUND

Cameras, video cameras, mirrorless cameras, single-lens reflex cameras, action cameras, smartphones, monitors, photography lighting, and other related photographic equipment or digital products often need to be mounted and secured on tripod gimbals, camera or smartphone stabilizers, slid rails, backpack clips, or dedicated mounting bases during use. Typically, a quick-assembly plate device is employed for this purpose. Taking the example of mounting a camera on a tripod gimbal, a screw hole (or a threaded receptacle) is formed at the bottom of the camera. An existing quick-assembly plate (usually square or rectangular) is tightly secured to the threaded receptacle at the bottom of the camera using a screw. Once the quick-assembly plate is attached, the camera can then be mounted and fastened onto the tripod gimbal (the shape of the quick-assembly plate generally conforms to the standard Arca-Swiss interface, though non-standard mounting interfaces may also be used, all of which allow for convenient and secure attachment to the tripod gimbal), thereby enabling shooting.

However, this mounting method presents a drawback. When the camera is tilted or panned for framing and composition, the screw for securing the quick-assembly plate to the camera tends to loosen easily. This not only affects the photographer's efficiency but also poses a risk of the camera detaching if overlooked. Particularly with the emergence of new photography equipment and shooting techniques, such as action cameras mounted on helmets, handheld poles, or backpack clips for dynamic shooting, photographers securing cameras to backpack clips while walking, or cameras/smartphones mounted on stabilizers using quick-assembly plates, the constant motion, shaking, and jostling of the photography equipment make the screws for locking the quick-assembly plates and the cameras highly prone to loosening. Moreover, photographers may not easily notice the loosening, which can lead to complete screw detachment, causing the quick-assembly plates and photographic equipment such as cameras to separate. This frequently results in accidental drops and damage to photographic equipment such as cameras. To address this issue, we have developed an anti-loosening and anti-rotation quick-assembly plate for photographic and digital products.

### SUMMARY

In order to solve the drawbacks in the prior art, the present disclosure proposes an anti-loosening and anti-rotation quick-assembly plate for photographic and digital products to solve the problem that a traditional quick-assembly plate becomes loose from photographic equipment in use.

To achieve the above objective, the present disclosure adopts the following technical solutions.

An anti-loosening and anti-rotation quick-assembly plate for photographic and digital products includes a quick-assembly plate and a large screw, where a storage groove is formed in a lower side of the quick-assembly plate; the large screw is disposed within the storage groove; and an anti-loosening fastening assembly for preventing loosening of photographic equipment is disposed between the large screw and the quick-assembly plate, and includes a plurality of connection holes formed in a head of the large screw, a plurality of positioning holes formed in an inner top surface of the storage groove, and a fastener threadedly connectable between the connection hole and the positioning hole.

With the above technical solution, the photographic equipment is mounted on the quick-assembly plate and then connected using the large screw, while the connection hole in the head of the large screw is aligned with the positioning hole in the storage groove. The fastener is threadedly connected in the positioning hole through the connection hole to reinforce the large screw and the quick-assembly plate, whereby the mounted photographic equipment is connected stably and prevented from loosening.

Preferably, the fastener is a small screw.

Preferably, a mounting groove is formed at the center of the head of the large screw, and the small screw is removably connectable in the mounting groove by means of a screw thread.

With the above technical solution, the mounting groove is provided for receiving the small screw.

Preferably, a threaded hole is formed at the center of the inner top surface of the storage groove, and a tail of the large screw is threadedly connected in the threaded hole.

With the above technical solution, the threaded hole is provided for threaded connection between the large screw and the quick-assembly plate.

Preferably, two anti-slip silicone pads are symmetrically embedded on an upper side of the quick-assembly plate in parallel.

With the above technical solution, the anti-slip silicone pads are provided for preventing slipping of the photographic equipment on the quick-assembly plate while increasing the frictional force between the quick-assembly plate and the photographic equipment.

Preferably, the plurality of connection holes are formed in the head of the large screw and circumferentially arranged concentrically about a center point of the storage groove; and the plurality of positioning holes are circumferentially arranged concentrically about the center point of the storage groove.

With the above technical solution, the connection holes and the positioning holes are arranged concentrically, facilitating both the positioning of the connection hole and the positioning hole and the connection and locking by the fastener.

To sum up, according to the present disclosure, the photographic equipment is mounted on the quick-assembly plate and then connected using the large screw, while the connection hole in the head of the large screw is aligned with the positioning hole in the storage groove. The fastener is threadedly connected in the positioning hole through the connection hole to reinforce the large screw and the quick-assembly plate, whereby the mounted photographic equipment is connected stably and prevented from loosening.

According to the present disclosure, the anti-slip silicone pads are provided for preventing slipping of the photographic equipment on the quick-assembly plate while increasing the frictional force between the quick-assembly plate and the photographic equipment.

### BRIEF DESCRIPTION OF THE DRAWINGS

FIG. 1 is an exploded axonometric schematic diagram of a front side of the present disclosure;

FIG. 2 is an exploded axonometric schematic diagram of a bottom side of the present disclosure;

FIG. 3 is an axonometric structural schematic diagram of a front side of the present disclosure in a normal state;

FIG. 4 is a cross-sectional axonometric structural schematic diagram of a front side of the present disclosure in a normal state; and

FIG. 5 is a cross-sectional axonometric structural schematic diagram of a front side of the present disclosure in a locked state.

List of Reference Numerals: 1—quick-assembly plate; 2—storage groove; 3—large screw; 4—mounting groove; 5—small screw; 6—connection hole; 7—positioning hole; 8—threaded hole; and 9—anti-slip silicone pad.

### DETAILED DESCRIPTION OF THE EMBODIMENTS

The technical solutions in embodiments of the present disclosure will be described below clearly and completely with reference to the accompanying drawings in the embodiments of the present disclosure. Apparently, the described embodiments are merely some, rather than all of the embodiments of the present disclosure.

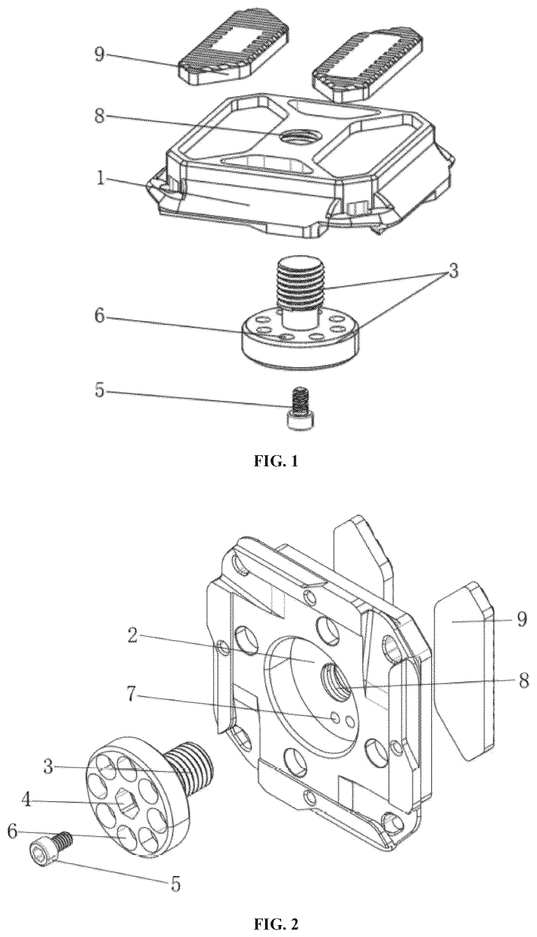

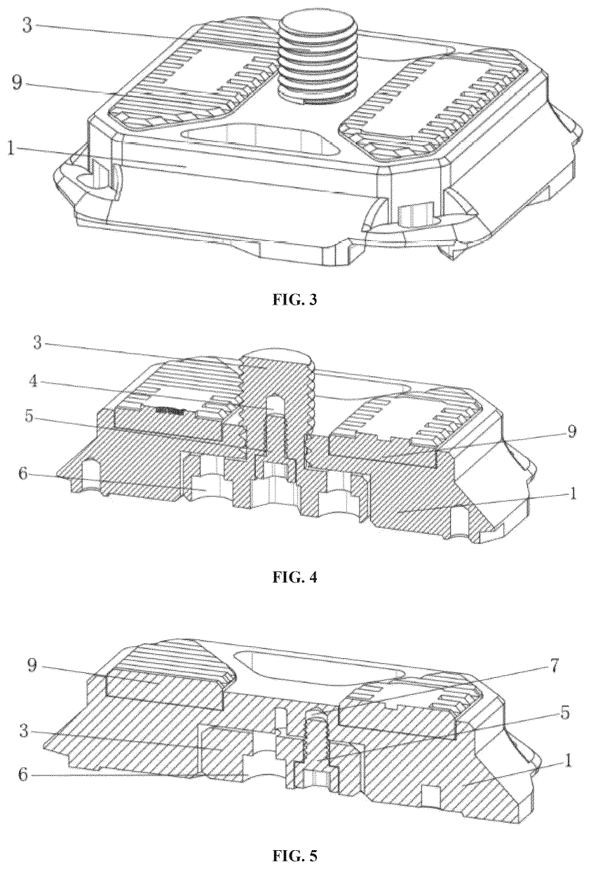

As shown in FIG. 1 to FIG. 5, an anti-loosening and anti-rotation quick-assembly plate for photographic and digital products includes a quick-assembly plate 1 and a large screw 3. A storage groove 2 is formed in a lower side of the quick-assembly plate 1, and the large screw 3 is disposed within the storage groove 2. An anti-loosening fastening assembly for preventing loosening of photographic equipment is disposed between the large screw 3 and the quick-assembly plate 1, and includes a plurality of connection holes 6 formed in a head of the large screw 3, a plurality of positioning holes 7 formed in an inner top surface of the storage groove 2, and a fastener threadedly connectable between the connection hole 6 and the positioning hole 7. The fastener is a small screw 5. A mounting groove 4 is formed at the center of the head of the large screw 3, and the small screw 5 is removably connected in the mounting groove 4 by means of a screw thread. A threaded hole 8 is formed at the center of the inner top surface of the storage groove 2, and a tail of the large screw 3 is threadedly connected in the threaded hole 8. Two anti-slip silicone pads 9 are symmetrically embedded on an upper side of the quick-assembly plate 1 in parallel.

In this embodiment, a user first secures the quick-assembly plate 1 to a camera or photographic equipment by tightening the large screw 3 into the threaded hole 8. Next, the small screw 5 hidden within the large screw 3 is taken out using a wrench. The large screw 3 is then fine-adjusted to align the connection holes 6 in the large screw 3 with the positioning holes 7 in the storage groove 2 up and down. The small screw 5 is then inserted into the connection hole 6 and threadedly connected in the corresponding positioning hole 7, firmly securing the quick-assembly plate 1 and the large screw 3 together. This ensures that the large screw 3 cannot rotate or loosen even when the camera or photographic equipment is subjected to shaking or vibrations. Additionally, large anti-slip silicone pads 9 are mounted on the side of the quick-assembly plate 1 that is fit with the bottom of the camera or photographic equipment. The anti-slip silicone pads 9 can guarantee that under normal usage (excluding forceful manual twisting of the photographic equipment such as the camera and the quick-assembly plate), the large screw 3 remains locked in place on the quick-assembly plate. As a result, the connection between the quick-assembly plate 1 and the camera or photographic equipment remains secure without loosening, rotation, or detachment.

It needs to be noted that in a normal state, the small screw 5 is threadedly connected in the mounting groove 4 and hidden inside the large screw 3.

The number of the connection holes 6 and that of the positioning holes 7 may be one or more.

The connection hole 6 and the positioning hole 7 may be circular holes or slotted holes.

The small screw 5 may be threadedly connected in the mounting groove 4, or may be threadedly connected in the connection hole 6 or in the positioning hole 7.

The above merely describes specific embodiments of the present disclosure, but the protection scope of the present disclosure is not limited thereto. A person skilled in the art can easily conceive modifications or replacements according to the technical solutions and ideas of the present disclosure within the technical scope of the present disclosure, and these modifications or replacements shall fall within the protection scope of the present disclosure.

What is claimed is:

1. An anti-loosening and anti-rotation quick-assembly plate for photographic and digital products, comprising a quick-assembly plate (1) and a large screw (3), wherein a storage groove (2) is formed in a lower side of the quick-assembly plate (1); the large screw (3) is disposed within the storage groove (2); and an anti-loosening fastening assembly for preventing loosening of photographic equipment is disposed between the large screw (3) and the quick-assembly plate (1), the anti-loosening fastening assembly comprises a plurality of connection holes (6) formed in a head of the large screw (3), a plurality of positioning holes (7) formed in an inner top surface of the storage groove (2), and a fastener threadedly connectable between the connection hole (6) and the positioning hole (7).

2. The anti-loosening and anti-rotation quick-assembly plate for photographic and digital products according to claim 1, wherein the fastener is a small screw (5).

3. The anti-loosening and anti-rotation quick-assembly plate for photographic and digital products according to claim 2, wherein a mounting groove (4) is formed at a center of the head of the large screw (3); and the small screw (5) is removably connectable in the mounting groove (4) by means of a screw thread.

4. The anti-loosening and anti-rotation quick-assembly plate for photographic and digital products according to claim 1, wherein a threaded hole (8) is formed at a center of the inner top surface of the storage groove (2); and a tail of the large screw (3) is threadedly connected in the threaded hole (8).

5. The anti-loosening and anti-rotation quick-assembly plate for photographic and digital products according to claim 1, wherein two anti-slip silicone pads (9) are symmetrically embedded on an upper side of the quick-assembly plate (1) in parallel.

6. The anti-loosening and anti-rotation quick-assembly plate for photographic and digital products according to claim 1, wherein the plurality of connection holes (6) are formed in the head of the large screw (3) and circumferentially arranged concentrically about a center point of the storage groove (2); and the plurality of positioning holes (7) are circumferentially arranged concentrically about the center point of the storage groove (2).
